(19) United States
(12) Patent Application Publication
(10) Pub. No.: US 2025/0060522 A1
(43) Pub. Date: Feb. 20, 2025

(54) WAVEGUIDE COMBINER WITH IN-PLANE RELAY AND WAVEGUIDE DISPLAY SYSTEM INCLUDING THE SAME

(71) Applicant: Meta Platforms Technologies, LLC, Menlo Park, CA (US)

(72) Inventors: Jian XU, Redmond, WA (US); Joshua COBB, Victor, NY (US)

(21) Appl. No.: 18/781,931

(22) Filed: Jul. 23, 2024

Related U.S. Application Data
(60) Provisional application No. 63/520,014, filed on Aug. 16, 2023.

(51) Int. Cl. F21V 8/00; G02B 27/01

(52) U.S. Cl. CPC G02B 6/0018; G02B 6/0016; G02B 6/0035; G02B 27/0172

(57) ABSTRACT

A system includes a waveguide configured to guide an in-coupled image light to propagate inside the waveguide via total internal reflection. The system also includes an in-coupling element configured to couple an input image light into the waveguide as the in-coupled image light. The system also includes a plurality of partial reflectors at least partially embedded inside the waveguide. The system further includes an in-plane relay at least partially embedded inside the waveguide and disposed between the in-coupling element and the partial reflectors. The in-plane relay includes a plurality of cylindrical reflectors. The in-plane relay is configured to convert the in-coupled image light received from the in-coupling element into a relayed image light.

### CROSS REFERENCE TO RELATED APPLICATION

This application claims the benefit of priority to U.S. Provisional Application No. 63/520,014, filed on Aug. 16, 2023. The content of the above-referenced application is incorporated by reference in its entirety.

### TECHNICAL FIELD

The present disclosure generally relates to optical devices and systems, more specifically, to a waveguide combiner with an in-plane relay and a waveguide display system including the same.

### BACKGROUND

An artificial reality system, such as a head-mounted display (“HMD”) or heads-up display (“HUD”) system, generally includes a near-eye display (“NED”) system in the form of a headset or a pair of glasses. The NED system is configured to present content to a user via an electronic or optic display within, for example, about 10-20 mm in front of the eyes of a user. The NED system may display virtual objects or combine images of real objects with virtual objects, as in VR, AR, or MR applications. For example, in an AR or MR system, a user may view both images of virtual objects (e.g., computer-generated images (“CGIs”)) and the surrounding environment by, for example, seeing through transparent display glasses or lenses.

One example of an AR system may include a pupil-expansion waveguide display system, in which an image light representing a CGI may be coupled into a waveguide, propagate within the waveguide via totally internal reflection, and be coupled out of the waveguide at different locations to expand an effective pupil. The waveguide may also combine the image light representing the CGI and a light from a real-world environment, such that the virtual image may be superimposed with real-world images.

### SUMMARY OF THE DISCLOSURE

According to an aspect of the present disclosure, a system is provided. The system includes a waveguide configured to guide an in-coupled image light to propagate inside the waveguide via total internal reflection. The system also includes an in-coupling element configured to couple an input image light into the waveguide as the in-coupled image light. The system also includes a plurality of partial reflectors at least partially embedded inside the waveguide. The system further includes an in-plane relay at least partially embedded inside the waveguide and disposed between the in-coupling element and the partial reflectors. The in-plane relay includes a plurality of cylindrical reflectors. The in-plane relay is configured to convert the in-coupled image light received from the in-coupling element into a relayed image light.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed examples and are not intended to limit the scope of the present disclosure. In the drawings:

FIGS. 1A-1C illustrate schematic diagrams of a conventional geometrical waveguide display system;

FIG. 2A illustrates a three-dimensional (“3D”) view of a geometrical waveguide display system configured to increase an eye-box efficiency, according to an example of the present disclosure;

FIG. 2B illustrates a diagram of a light source assembly in the system shown in FIG. 2A, according to an example of the present disclosure;

FIG. 2C illustrates a cross-sectional view of a portion of a waveguide in the system shown in FIG. 2A, according to an example of the present disclosure;

FIG. 2D illustrates a cross-sectional view of a portion of a waveguide in the system shown in FIG. 2A, according to an example of the present disclosure;

FIGS. 3A and 3B illustrate various sectional views of an in-plane relay in the system shown in FIG. 2A, showing an optical path of an in-coupled image light throughout the in-plane relay, according to one or more examples of the present disclosure;

FIGS. 3C-3E illustrate various sectional views of the waveguide, showing an optical path of a relayed image light throughout a folding element and an out-coupling element in the system shown in FIG. 3A, according to one or more examples of the present disclosure;

FIG. 4A illustrates a schematic diagram of an artificial reality device, according to an example of the present disclosure; and

FIG. 4B illustrates a schematic cross sectional view of half of the artificial reality device shown in FIG. 4A, according to an example of the present disclosure.

### DETAILED DESCRIPTION

Various aspects of the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

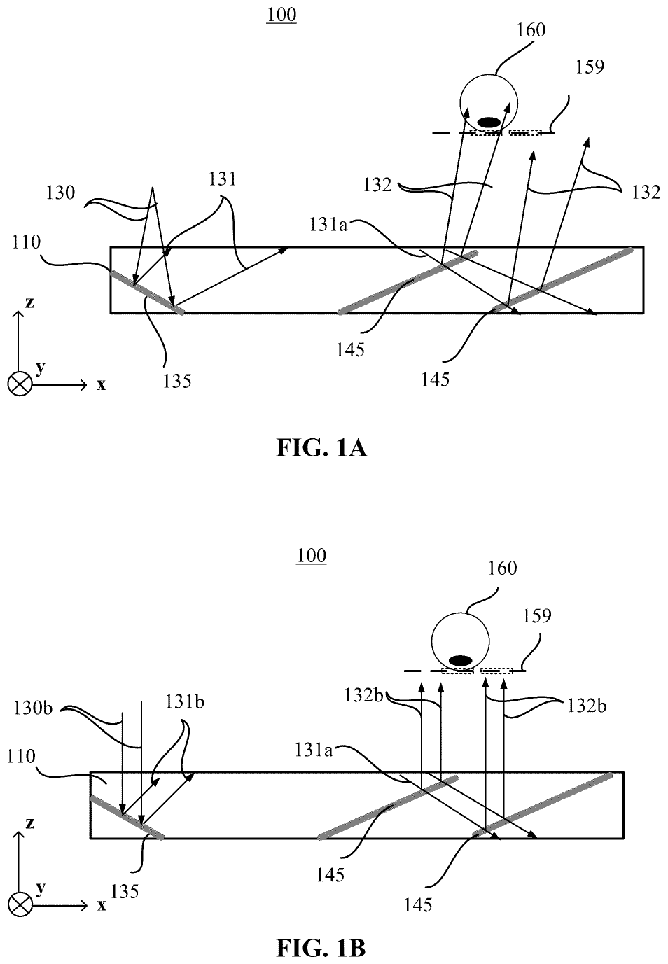

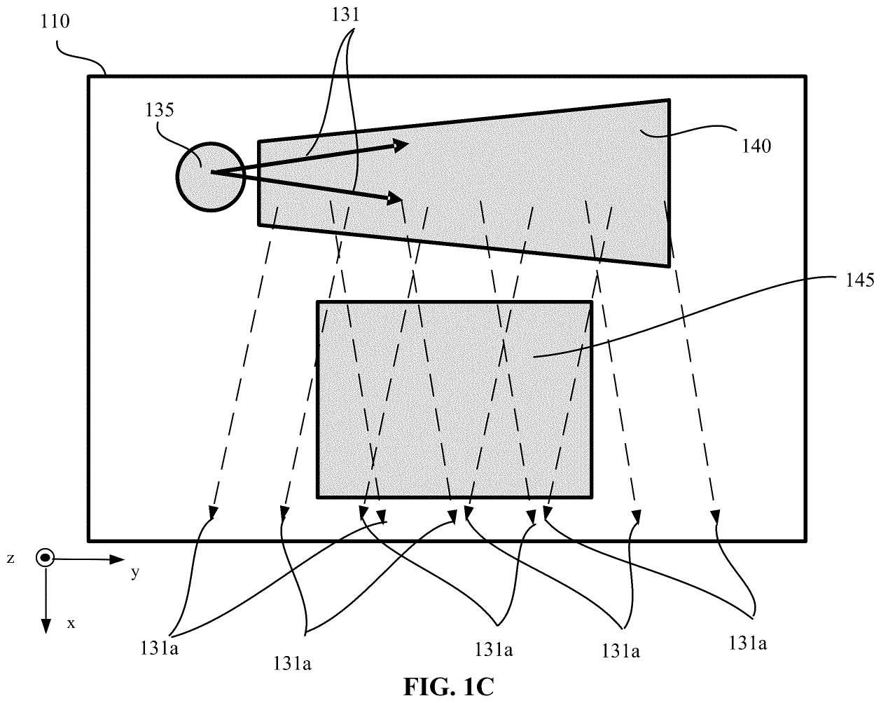

FIGS. 1A and 1B illustrate x-z sectional views of a conventional geometrical waveguide display system 100 (also referred to as system 100, or waveguide display system 100). FIG. 1C illustrates an x-y sectional views of the system 100 shown in FIGS. 1A and 1B. The system 100 may include a light source assembly (not shown), a waveguide 110, an in-coupling mirror 135, an array of folding mirrors 140 (shown in FIG. 1C), and an array of out-coupling mirrors 145. The in-coupling mirror 135, the folding mirrors 140, and the out-coupling mirrors 145 may be embedded inside different portions of the waveguide 110. The in-coupling mirror 135 may be a highly reflective mirror. The folding mirrors 140 in the array may be arranged in parallel along a first direction, e.g., a y-axis direction. The out-coupling mirrors 145 in the array may be arranged in parallel along a second direction, e.g., an x-axis direction. Each of the folding mirror 140 and the out-coupling mirror 145 may be a facet including a flat partial reflective surface, which reflects a portion of an incident light as a reflected light and transmits the remaining portion of the incident light as a transmitted light. The flat partial reflective surface may not change the degree of the divergence or the degree of the convergence of the light while reflecting and transmitting the light. The flat partial reflective surfaces of the folding mirrors 140 in the array may be arranged in parallel with one another, and the flat partial reflective surfaces of the out-coupling mirrors 145 in the array may be arranged in parallel with one another.

The light source assembly may emit an image light (referred to as an input image light) 130 representing a virtual image toward the waveguide 110. The input image light 130 may be a divergent image light that includes a plurality of bundles of parallel rays. FIG. 1A illustrates an optical path of the input image light 130 inside the system 100, and FIG. 1B illustrates an optical path of a single bundle of parallel rays 130b in the input image light 130 inside the system 100. The waveguide 110 including the in-coupling mirror 135, the folding mirrors 140, and the out-coupling mirrors 145 may guide or deliver the divergent input image light 130 (that is formed by a plurality of bundles of parallel rays) as a plurality of divergent output image lights 132 (each image light 132 is formed by a plurality of bundles of parallel rays) propagating toward an eye-box region 159. An eye 160 of a user of the system 100 may be positioned within the eye-box region 159 to perceive the virtual image. In addition, the waveguide 110 may also receive a light from a real-world environment (referred to as a real-world light), and may combine the real-world light with the output image lights 132, and deliver the combined light to the eye-box region 159. Thus, the waveguide 110 including the multiple embedded mirrors may also be referred to as a geometric waveguide combiner or an image combiner.

As shown in FIGS. 1A-1C, the in-coupling mirror 135 may couple the input image light 130 into the waveguide 110 as an in-coupled image light 131 propagating inside the waveguide 110 via total internal reflection (“TIR”) toward the array of folding mirrors 140. As shown in FIG. 1C, the in-coupled image light 131, which is a divergent image light, may be incident onto the folding mirror 140. Each folding mirror 140 may reflect a portion of the in-coupled image light 131 as a redirected image light 131a (indicated by dashed arrows) propagating toward the array of out-coupling mirrors 145, and transmit the remaining portion of the in-coupled image light 131 for further TIR propagation toward a next folding mirror 140. The redirected image light 131a may be a divergent image light. Thus, the array of folding mirrors 140 may split the in-coupled image light 131 into a plurality of divergent redirected image lights 131a (indicated by dashed arrows in FIG. 1C) propagating toward the array of out-coupling mirrors 145, thereby expanding the input image light 130 in the first direction (e.g., the y-axis direction). For discussion purposes, FIG. 1C shows five redirected image lights 131a (denoted by dashed arrows) propagating inside the waveguide 110 toward the array of out-coupling mirrors 145.

Referring back to FIG. 1A, when each of the divergent redirected image lights 131a may be incident onto the out-coupling mirrors 145, each out-coupling mirror 145 may couple, via reflection, a portion of the redirected image light 131a out of the waveguide 110 as an output image light 132, and transmit the remaining portion of the redirected image light 131a for further TIR propagation toward a next out-coupling mirror 145. Thus, each redirected image light 131a may be reflected by the array of out-coupling mirrors 145 as a plurality of output image lights 132, and the array of out-coupling mirrors 145 may expand the input image light 130 in the second direction (e.g., the x-axis direction). For discussion purposes, FIG. 1A merely shows two output image lights 132 (from two out-coupling mirrors 145), which may be divergent image lights. Thus, the waveguide 110 with the embedded out-coupling mirrors 145 and folding mirrors 140 may provide a 2D pupil replication at the output side of the waveguide 110.

In addition, the rays in each bundle of the input image light 130 may remain parallel rays when propagating throughout the geometric waveguide combiner. For example, FIG. 1B shows that the in-coupling mirror 135 couples a bundle of parallel rays 130b in the input image light 130 as a bundle of parallel rays 131b in the in-coupled image light 131. The array of folding mirrors 140 and the array of out-coupling mirrors 145 may convert the bundle of parallel rays 131b into a plurality of bundles (e.g., two) of parallel rays 132b of the output image lights 132.

The conventional waveguide display system 100 shown in FIGS. 1A-1C may have a low eye-box efficiency (e.g., below 5%) due to the layout waste, and the face illumination waste. The eye-box efficiency is a ratio between the energy received by the eye-box region 159 and the energy output by a display element (e.g., projector) included in the light source assembly. FIG. 1B shows the layout waste in the system 100, and FIG. 1A shows the face illumination waste in the system 100. As shown in FIG. 1B, when the redirected image lights 131a, which may be divergent image lights, are incident onto the array of out-coupling mirrors 145, some of the redirected image lights 131a may not be received by the array of out-coupling mirrors 145, and may be lost. As shown in FIG. 1A, when the redirected image lights 131a are incident onto the array of out-coupling mirrors 145, the array of out-coupling mirrors 145 may reflect the redirected image lights 131a as the divergent output image lights 132 propagating toward the eye-box region 159. The size of the array of out-coupling mirrors 145 is often greater than the size of the eye-box region 159. Thus, a portion of the output image lights 132 may propagate through the eye-box region 159, and the remaining portion(s) of the output image lights 132 may be incident onto the face of the user, illuminating the face. Due to the layout waste and the face illumination waste, the eye-box efficiency of the conventional waveguide display system 100 may be as low as 2%-3%. That is, the conventional waveguide display system 100 may be power inefficient.

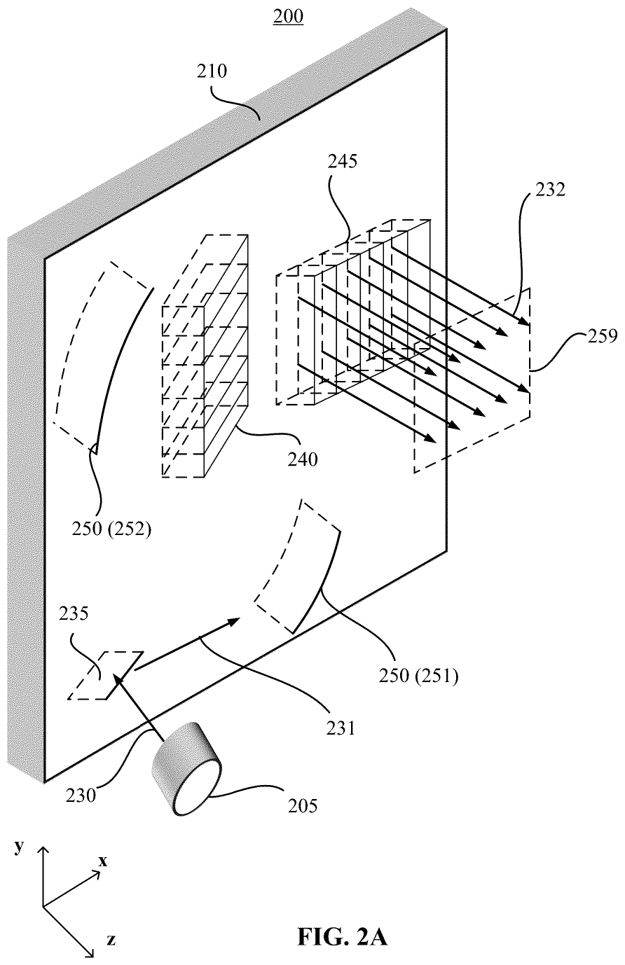

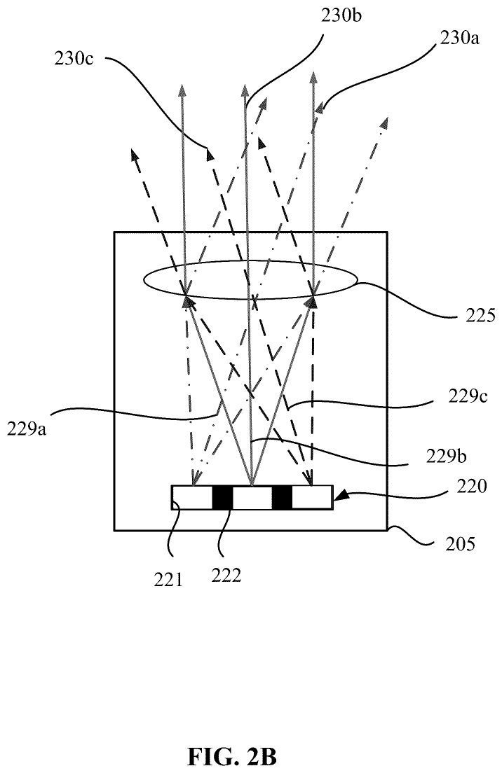

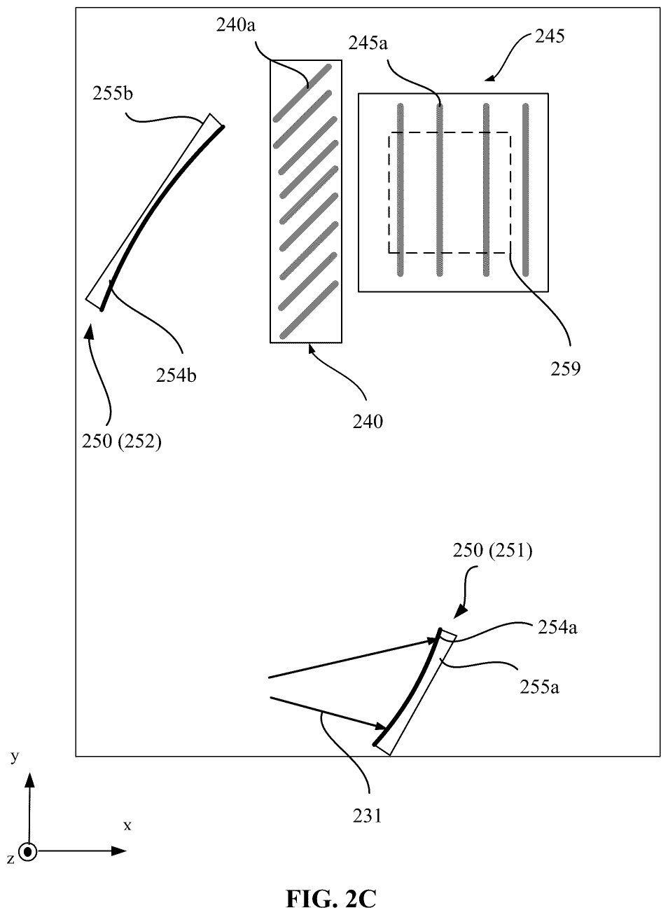

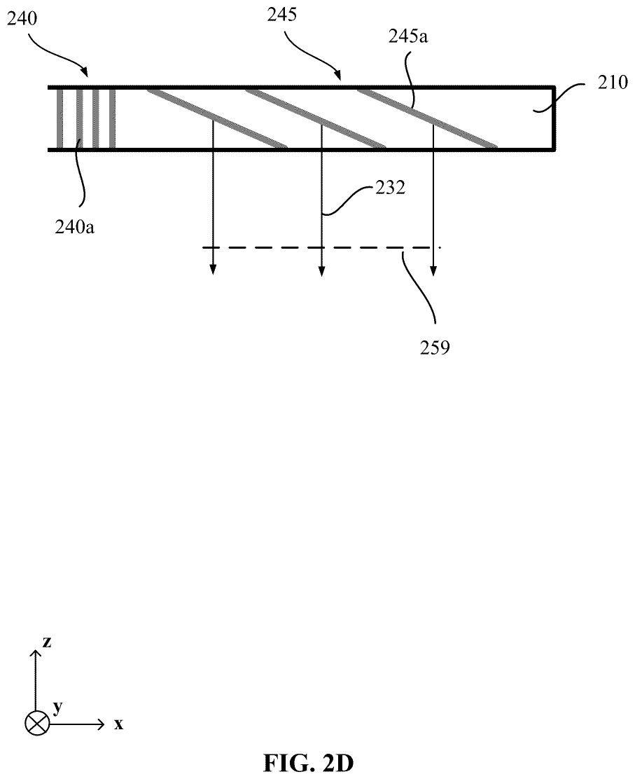

In view of the limitations in the conventional technologies, the present disclosure provides an optical waveguide combiner including an in-plane relay, and a display system configured to increase the eye-box efficiency via the in-plane relay. FIG. 2A illustrates a three-dimensional (“3D”) view of a geometrical waveguide display system 200 (referred to as system 200 for simplicity) configured to provide an improved eye-box efficiency (or optical efficiency), according to an example of the present disclosure. The system 200 may be implemented into an artificial reality device or system for VR, AR, and/or MR applications. As shown in FIG. 2A, the system 200 may include a light source assembly 205, a waveguide 210, an in-coupling element 235, a folding element 240 (also referred to as a redirecting element 240), an out-coupling element 245, and an in-plane relay 250. In some examples, the in-coupling element 235, the folding element 240, the out-coupling element 245, and the in-plane relay 250 may be at least partially (including fully) embedded inside different portions of the waveguide 210. In some examples, the in-coupling element 235 may not be embedded inside the waveguide 210, and may be disposed at (e.g., on) a surface of the waveguide 210.

The light source assembly 205 may be configured to output an image light (also referred to as an input image light) 230 representing a virtual image. The waveguide 210, together with the in-coupling element 235, the folding element 240, the out-coupling element 245, and the in-plane relay 250, may guide the propagation of the input image light 230 and output the input image light 230 as a plurality of output image lights 232, which propagate toward an eye-box region 259 of the system 200. The system 200 may provide an improved eye-box efficiency. The waveguide 210 may also transmit a light from a real-world environment (referred to as a real-world light) toward the eye-box region 259, such that the virtual image represented by the output image lights 232 may be superimposed with a real-world image represented by the real-world light. Thus, the waveguide 210, the in-coupling element 235, the folding element 240, the out-coupling element 245, and the in-plane relay 250 may be collectively referred to as a waveguide combiner.

FIG. 2B illustrates a diagram of the light source assembly 205 included in the system 200 shown in FIG. 2A, according to an example of the present disclosure. As shown in FIG. 2B, the light source assembly 205 may include a display element 220 (e.g., a projector) and a collimating lens 225. The display element 220 may include a plurality of pixels 221 arranged in a pixel array, in which neighboring pixels 221 may be separated by, e.g., a black matrix 222. The display element 220 may output an image light 229, which includes a plurality of bundles of divergent rays output from the respective pixels 221. For illustrative purposes, FIG. 2B shows that the display element 220 includes three pixels 221, and three bundles 229a, 229b, and 229c of divergent rays output from the three pixels 221.

The collimating lens 225 may convert the bundles 229a, 229b, and 229c of divergent rays in the image light 229 into bundles 230a, 230b, and 230c of parallel rays in the input image light 230. The respective bundles 230a, 230b, and 230c of parallel rays in the input image light 230 may have different propagation directions, and may have different incidence angles at the waveguide 210 and the in-coupling element 235. That is, the collimating lens 225 may transform or convert a linear distribution of the pixels 221 in the image light 229 into an angular distribution of the pixels in the input image light 230. In other words, the collimating lens 225 may transform or convert the image light 229 carrying a virtual image in the linear domain into the input image light 230 carrying the same virtual image in the angular domain.

Referring to FIGS. 2A-2B, the in-coupling element 235 may be at least partially (including fully) embedded inside a first portion (e.g., input portion) of the waveguide 210. The in-coupling element 235 may be configured to couple the input image light 230 as an in-coupled image light 231 propagating inside the waveguide 210 via TIR. In some examples, the in-coupling element 235 may include a highly reflective mirror. The reflectance of the in-coupling element 235 may be greater than 95%. For discussion purposes, the in-coupling element 235 may be referred to as an in-coupling mirror 235. The in-coupling mirror 235 may be configured to reflect the input image light 230 into a TIR propagation path inside the waveguide 210. In particular, the in-coupling mirror 235 may couple the respective bundles 230a, 230b, and 230c of parallel rays in the input image light 230 into the waveguide 210 as respective bundles of parallel rays in the in-coupled image light 231. The in-coupled image light 231 may propagate inside the waveguide 210 via TIR, toward the in-plane relay 250, the folding element 240, and the out-coupling element 245.

FIG. 2C illustrates an x-y sectional view of a portion of the system 200 shown in FIG. 2A, according to an example of the present disclosure. FIG. 2D illustrates an x-z sectional view of a portion of the system 200 shown in FIG. 2A, according to an example of the present disclosure. Referring to FIG. 2A and FIG. 2C, the in-plane relay 250 may be at least partially (including fully) embedded inside a second portion of the waveguide 210, the folding element 240 may be at least partially (including fully) embedded inside a third portion of the waveguide 210, and the out-coupling element 245 may be at least partially (including fully) embedded inside a fourth portion (e.g., an output portion) of the waveguide 210. The second portion of the waveguide 210 where the in-plane relay 250 is at least partially (including fully) embedded may be located between the first portion where the in-coupling element 235 is at least partially (including fully) embedded and the third portion where the folding element 240 is at least partially (including fully) embedded.

As shown in FIG. 2A, the in-plane relay 250 may include a pair of reflectors 251 and 252 optically coupled to one another. One or both of the reflectors 251 and 252 may be configured with a predetermined optical power (e.g., a positive or negative optical power). In some examples, one or both of the reflectors 251 and 252 may function as a cylindrical mirror having a high reflectance (e.g., greater than or equal to 95%). For discussion purposes, the reflectors 251 and 252 may also be referred to as a first cylindrical mirror 251 and a second cylindrical mirror 252, respectively. Referring to FIG. 2C, the cylindrical mirror 251 or 252 may include a reflective layer 254a or 254b (also referred to as reflective surface 254a or 254b), and a substrate 255a or 255b for supporting and protecting the reflective layer 254a or 254b. In some examples, the cylindrical mirror 251 or 252 may not include the substrate 255a or 255b, and the reflective layer 254a or 254b may have a sufficient rigidity, e.g., may be a free-standing layer. In some examples, when the cylindrical mirror 251 or 252 includes the substrate 255a or 255b, the substrate 255a or 255b may include a cylindrical lens having a flat surface and a curved surface, and the reflective layer 254a or 254b may be disposed at the curved surface of the substrate 255a or 255b.

In some examples, the cylindrical mirror 251 or 252 may have two orthogonal directions: an optical power direction and a non-optical-power direction. The optical power direction is a direction roughly along a curved length of the cylindrical mirror 251 or 252, and is the axis with optical power. The non-optical-power direction is a direction along the length direction of the cylindrical mirror 251 or 252 without any optical power. The length of the cylindrical mirror 251 or 252 along the non-optical-power direction may extend without affecting the optical power of the cylindrical mirror 251 or 252. In FIG. 2C, the non-optical-power direction of the cylindrical mirror 251 or 252 may be along the thickness direction of the waveguide 210, e.g., a z-axis direction shown in FIG. 2C.

The curved surface of the substrate 255a or 255b shown in FIG. 2C may be a suitable curved surface, such as a concave surface, a convex surface, or a freeform surface, etc. The cylindrical mirror 251 or 252 may be a suitable cylindrical mirror, such as a concave cylindrical mirror, a convex cylindrical mirror, or a freeform cylindrical mirror, etc. The curved surface of the cylindrical mirror 251 and the curved surface of the cylindrical mirror 251 may be arranged facing one another. For discussion purposes, FIG. 2C show that both the and 252 are concave cylindrical mirrors (or focusing cylindrical mirrors), and the curved surfaces face one another, such that a light reflected by one curved surface (e.g., the curved surface of the cylindrical mirror 251) may be received by the other curved surface (e.g., the curved surface of the cylindrical mirror 252). In some examples, although not shown, one of the cylindrical mirrors 251 and 252 may include a concave cylindrical mirror, and the other of the cylindrical mirrors 251 and 252 may include a convex cylindrical mirror. The concave cylindrical mirror and the convex cylindrical mirror may be positioned or configured such that a light may be transmitted between the concave cylindrical mirror and the convex cylindrical mirror. In some examples, one of the reflectors 251 and 252 may be a cylindrical mirror, and the other of the reflectors 251 and 252 may be a flat mirror. The cylindrical mirror and the flat mirror may be positioned or configured such that a light may be transmitted between the cylindrical mirror and the flat cylindrical mirror.

The folding element 240 may include an array of partial reflectors 240a, referred to as folding mirrors 240a for discussion purposes. In some examples, one or more (e.g., each) of the folding mirrors 240a may be a facet including a flat partial reflective surface. When a plurality of folding mirrors 240a are facets including a plurality of flat partial reflective surfaces, the plurality of flat partial reflective surfaces may be arranged in parallel with one other, in a first direction (e.g., a y-axis direction shown in FIG. 2A and FIG. 2C). The flat partial reflective surface of a folding mirror 240a may be titled by a first predetermined angle (e.g., 45°) with respect to the first direction (e.g., the y-axis direction).

Referring to FIG. 2A and FIG. 2D, the out-coupling element 245 may include an array of partial reflectors 245a, referred to as out-coupling mirrors 245a for discussion purposes. In some examples, one or more (e.g., each) of the out-coupling mirrors 245a may be a facet including a flat partial reflective surface. When a plurality of out-coupling mirrors 245a are facets including a plurality of flat partial reflective surfaces, the plurality of flat partial reflective surfaces may be arranged in parallel with one other, in a second direction (e.g., an x-axis direction shown in FIG. 2A and FIG. 2D). The flat partial reflective surface of an out-coupling mirror 245a may form a second predetermined angle (e.g., an acute angle, e.g., 30°) with respect to the surface (e.g., a surface within an x-y plane) of the waveguide 210.

Referring to FIGS. 2C and 2D, the partial reflector 240a or 245a (or partial reflective surface) may reflect a first portion of the in-coupled image light 231 incident onto the partial reflector 240a or 245a, and transmit a second portion of the in-coupled image light 231. The reflectance and the transmittance of the partial reflector 240a or 245a may be configurable depending on different applications. For example, in some examples, the reflectance and the transmittance of the folding mirror 240a (or out-coupling mirror 245a) may be configured to be about 15% and 85%, respectively. The transmittance and reflectance of the folding mirror 240a may be the same as or different from the transmittance and reflectance of the out-coupling mirror 245a.

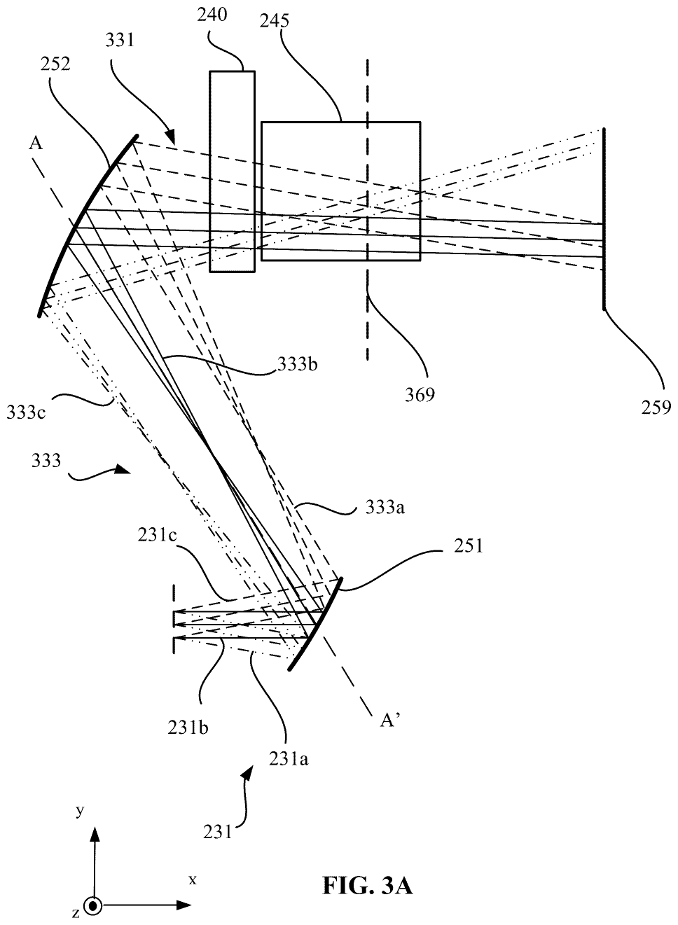

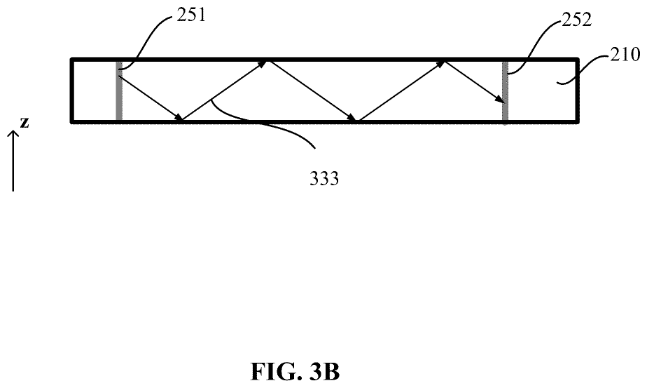

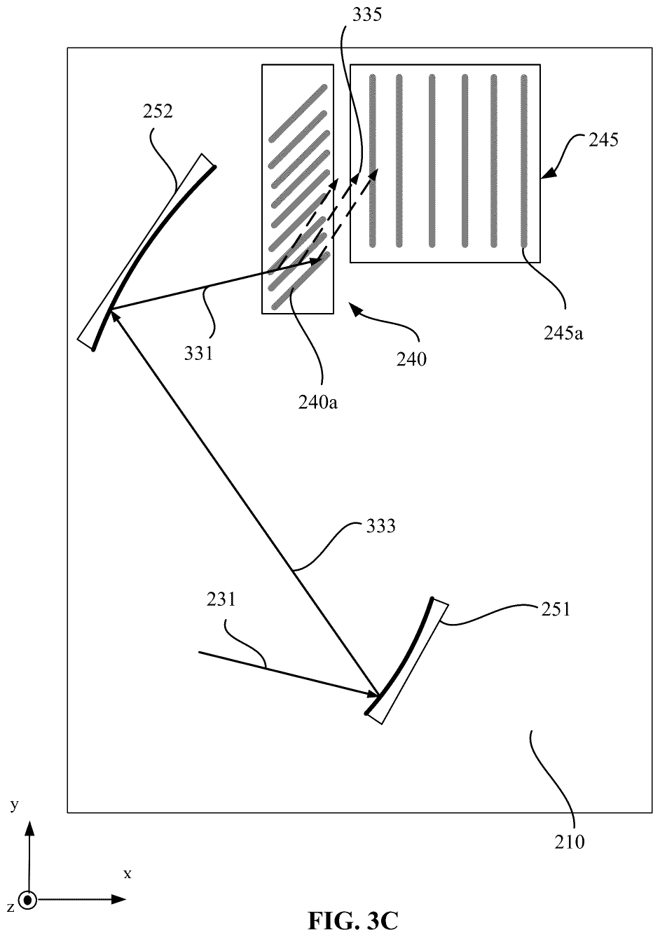

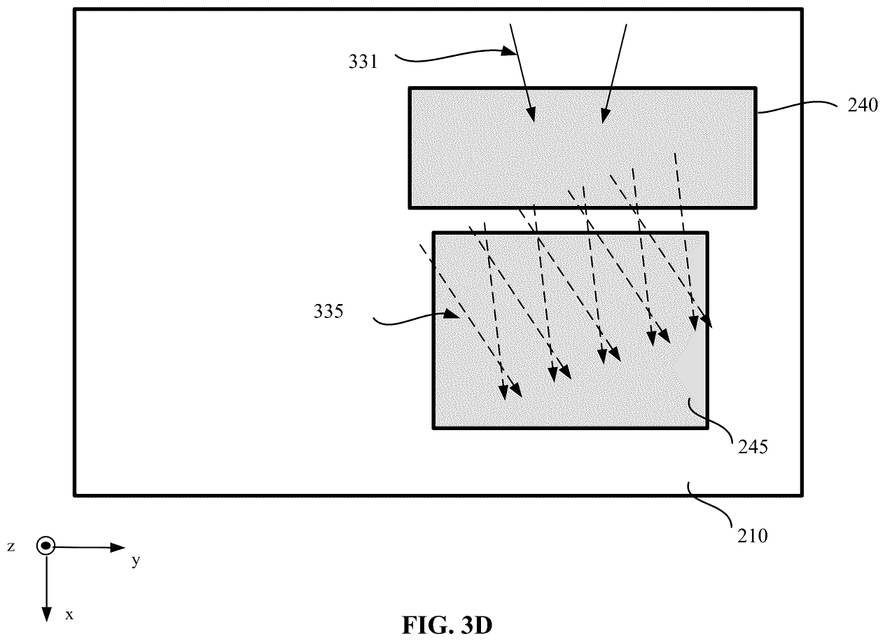

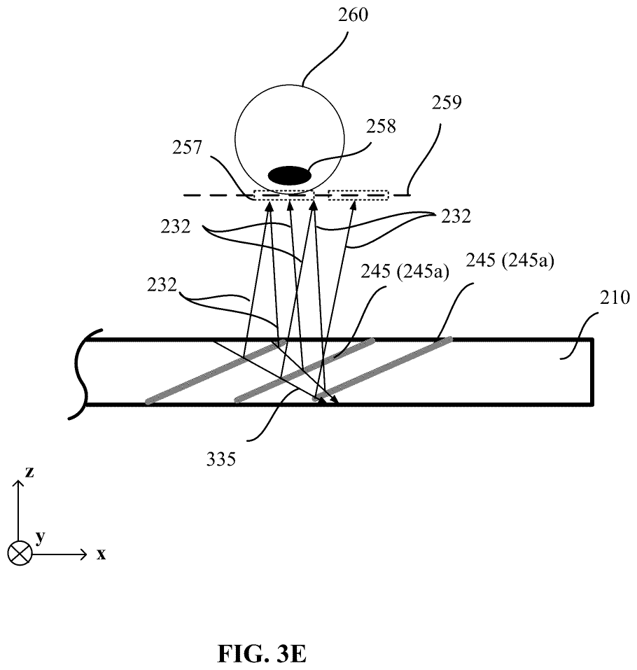

FIG. 3A illustrates an x-y sectional view of the in-plane relay 250, showing an optical path of the in-coupled image light 231 throughout the in-plane relay 250, according to an example of the present disclosure. FIG. 3B illustrates an A-A′ sectional view of the in-plane relay 250, showing an optical path of the in-coupled image light 231 throughout the in-plane relay 250, according to an example of the present disclosure. As shown in FIG. 3A, the in-coupled image light 231 may include a plurality of bundles 231a, 231b, and 231c of parallel rays, which may be respectively converted from the bundles 230a, 230b, and 230c of parallel rays in the input image light 230 via the in-coupling mirror 235 shown in FIGS. 2A and 2B.

Referring to FIG. 3A, the in-coupled image light 231 may be incident onto the first cylindrical mirror 251 of the in-plane relay 250 as a divergent image light. The in-plane relay 250 may be configured to convert the in-coupled image light 231 into a relayed image light 331. The in-plane relay 250 may convert the bundles 231a, 231b, and 231c of parallel rays in the in-coupled image light 231 into bundles 331a, 331b, and 331c of parallel rays of the relayed image light 331, respectively. The relayed image light 331 may be incident onto the folding element 240 as a convergent image light.

For example, the first cylindrical mirror 251 may be configured to convert, via reflection, the in-coupled image light 231 into an image light 333 propagating inside the waveguide 210 toward the second cylindrical mirror 252 via TIR, as shown in FIG. 3B. Referring back to FIG. 3A, the first cylindrical mirror 251 may reflect the bundles 231a, 231b, and 231c of parallel rays as bundles 333a, 333b, and 333c of non-parallel rays of the image light 333, respectively. The bundles 333a, 333b, and 333c of non-parallel rays of the image light 333 may be converged (or focused) to respective points at a focal plane of the first cylindrical mirror 251, then diverged (or defocused) toward the second cylindrical mirror 252. The second cylindrical mirror 252 may convert, via reflection, the image light 333 into the relayed image light 331 propagating toward the folding element 240. The second cylindrical mirror 252 may reflect the bundles 333a, 333b, and 333c of non-parallel rays of the image light 333 as the bundles 331a, 331b, and 331c of parallel rays of the relayed image light 331, respectively.

In some examples, the in-plane relay 250 may be configured to relay the virtual image represented by the in-coupled image light 231 received from the in-coupling element 235 to an intermediate image plane 369. In some examples, as shown in FIG. 3A, the intermediate image plane 369 may be located at the fourth portion of the waveguide 210 where the out-coupling element 245 may be at least partially (including fully) embedded. In some examples, although not shown, the intermediate image plane 369 may be located at the third portion of the waveguide 210 where the folding element 240 may be at least partially (including fully) embedded. In some examples, although not shown, the intermediate image plane 369 may be located between the third portion of the waveguide 210 where the folding element 240 may be at least partially (including fully) embedded and the fourth portion of the waveguide 210 where the out-coupling element 245 may be at least partially (including fully) embedded. In some examples, although not shown, the intermediate image plane 369 may be located outside of the waveguide 210. For example, the intermediate image plane 369 may be located at the eye-box region 259, e.g., at an eye pupil 258 of an eye 260 of a user that is positioned in the eye-box region 259. In some examples, the in-plane relay 250 may be configured to form an in-plane pupil relay optical assembly. In some examples, the in-plane relay 250 may be configured to form a suitable imaging assembly, such as a 4-f imaging assembly, a 2-f imaging assembly, a 1-f imaging assembly, or a 0.5-f imaging assembly, etc. In some examples, the in-plane relay 250 may also be configured to at least partially correct various optical aberrations in the in-coupled image light 231.

FIG. 3A merely illustrates an exemplary positional relationship of the relayed image light 331, the folding element 240, and the out-coupling element 245, and does not show the optical path of the relayed image light 331 throughout the folding element 240 and the out-coupling element 245. FIGS. 3C-3E illustrate various sectional view of the waveguide 210, showing an optical path of the relayed image light 331 throughout the folding element 240 and the out-coupling element 245, according to an example of the present disclosure. FIG. 3C illustrates an x-y sectional view of the waveguide 210, showing an optical path of a single ray in the relayed image light 331 throughout the folding element 240. FIG. 3D illustrates an x-y sectional view of the waveguide 210, showing an optical path of the relayed image light 331 throughout the folding element 240.

As shown in FIGS. 3C and 3D, when the relayed image light 331 is incident onto the array of folding mirrors 240a, one or more (e.g., each) of the folding mirrors 240a may reflect a portion of the relayed image light 331 as a redirected image light 335 (indicated by a dashed arrow) propagating toward the out-coupling element 245, and transmit the remaining portion of the relayed image light 331 for further TIR propagation toward a next folding mirror 240a. Thus, the array of folding mirrors 240a may split, via reflection, the relayed image light 331 into a plurality of redirected image lights 335 (indicated by dashed arrows) propagating toward the out-coupling element 245, thereby expanding the input image light 230 in the first direction (e.g., the y-axis direction). For discussion purposes, FIG. 3D shows that the array of folding mirrors 240a splits, via reflection, the relayed image light 331 into five redirected image lights 335. The redirected image lights 335 may be incident onto the array of out-coupling mirrors 245a as convergent image lights.

Compared to the conventional system 100 shown in FIG. 1B where the redirected image lights 131a are incident onto the array of out-coupling mirrors 145 as divergent image lights, the amount of the redirected image lights 335 that are received by the array of out-coupling mirrors 245a for being coupled out of the waveguide 210 may be increased, whereas the amount of the redirected image lights 335 that are not received by the array of out-coupling mirrors 245a may be reduced. Thus, compared to the conventional system 100 shown in FIG. 1B, the layout waste may be reduced in the system 200 shown in FIG. 3D.

FIG. 3E illustrates an x-z sectional view of the waveguide 210, showing an optical path of the relayed image light 331 (or the redirected image light 335) throughout the out-coupling element 245. As shown in FIG. 3E, when a redirected image light 335 is incident onto the array of out-coupling mirrors 245a, an out-coupling mirror 245a may couple, via reflection, a portion of the redirected image light 335 out of the waveguide 210 as an output image light 232, and transmit the remaining portion of the redirected image light 335 for further TIR propagation toward a next out-coupling mirror 245a. Thus, the redirected image light 335 may be reflected by the array of out-coupling mirrors 245a as a plurality of output image lights 232, thereby expanding the input image light 230 in the second direction (e.g., the x-axis direction). The output image lights 234 may be distributed along both the first direction and the second direction. For discussion purposes, FIG. 3E merely illustrates three output image lights 232 distributed along the second direction, and two rays of the respective output image light 232. Thus, the waveguide 210 with the at least partially embedded out-coupling element 245 and the at least partially embedded redirecting element 240 may provide a first beam expansion long the first direction and a second beam expansion long the second direction, thereby realizing the 2D pupil replication at the output side of the waveguide 210.

The output image lights 234 may propagate toward a plurality of exit pupils 257 located within the eye-box region 259 of the waveguide display system 200. An exit pupil 257 is a region in space where an eye pupil 258 of the eye 260 of a user is positioned in the eye-box region 259 to receive the content of a virtual image output from the display element. The exit pupils 257 may be arranged in a 2D array within the eye-box region 259. The eye-box region 259 overlaps with all, or most, of the practical positions of the eye pupil 258 of the user. This feature, referred to as “pupil expansion,” creates the effect of a full real-life image as perceived by the user, rather than a moving eye pupil characteristic provided by other viewing instruments (e.g., binoculars, microscopes, or telescopes).

Further, when the redirected image light 335 is incident onto the array of out-coupling mirrors 245a as a convergent image light, the output image lights 232 out-coupled from the array of out-coupling mirrors 245a may initially propagate in a convergent manner and then diverge towards the eye-box region 259. Compared to the conventional system 100 shown in FIG. 1A where the redirected image lights 131a are incident onto the array of out-coupling mirrors 145 as divergent image lights, and the output image lights 132 output from the array of out-coupling mirrors 145 propagate in a divergent manner towards the eye-box region 159, the amount of the output image lights 232 that are received by the eye-box region 259 may be increased, whereas the amount of the output image lights 232 that illustrate the face of the user may be reduced. Thus, compared to the conventional system 100 shown in FIG. 1A, the face illumination waste may be reduced in the system 200 shown in FIG. 3E. Referring to FIGS. 3A-3E, the layout waste and the face illumination waste may both be reduced in the system 200 including the in-plane relay 250. As a result, the eye-box efficiency may be significantly increased. The eye-box efficiency of the system 200 may be increased by at least ten times as compared to the conventional system 100 shown in FIGS. 1A-1C.

The system 200 shown in FIGS. 2A-3E is used as an example of geometric waveguide display systems for explaining the mechanisms and design principles to increase the eye-box efficiency. The arrangement of the various mirrors 251, 252, 240a, and 245a included in the system 200 shown in FIGS. 2A-3E are for illustrative purposes. In some examples, at least one of the in-coupling element 235 or the out-coupling element 245 may include one or more gratings that couple the light into or out of the waveguide via diffraction. The mechanisms and design principles disclosed herein for increasing the eye-box efficiency based on the in-plane relay may be applied to other suitable geometric waveguide display systems. For example, the couplers in the geometric waveguide display systems may include partially mirrors, beam splitters, fully reflective mirrors, or a combination thereof, etc. The mirrors in the geometric waveguide display systems may have suitable shapes, such as bar mirror arrays, pin-hole mirrors, etc. The geometric waveguide display system may be a one-dimensional (1D) geometric waveguide display system (that may not include a folding element), a two-dimensional (2D) geometric waveguide display system, or a Kaleido waveguide display system, etc.

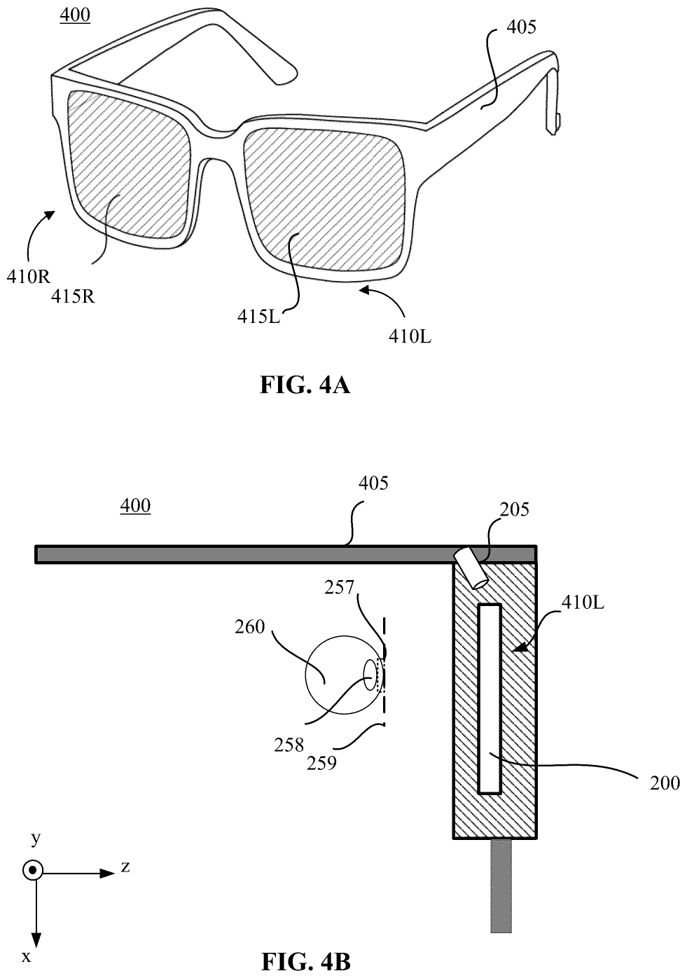

FIG. 4A illustrates a schematic diagram of an artificial reality device 400 according to an example of the present disclosure. The artificial reality device 400 may produce VR, AR, and/or MR content for a user, such as images, video, audio, or a combination thereof. For example, the artificial reality device 400 may be smart glasses, or may be a near-eye display (“NED”). In some examples, the artificial reality device 400 may be in the form of eyeglasses, goggles, a helmet, a visor, or some other type of eyewear. In some examples, the artificial reality device 400 may be configured to be worn on a head of a user (e.g., by having the form of spectacles or eyeglasses, as shown in FIG. 4A), or to be included as part of a helmet that is worn by the user. In some examples, the artificial reality device 400 may be configured for placement in proximity to an eye or eyes of the user at a fixed location in front of the eye(s), without being mounted to the head of the user. In some examples, the artificial reality device 400 may be in a form of eyeglasses which provide vision correction to a user's eyesight. In some examples, the artificial reality device 400 may be in a form of sunglasses which protect the eyes of the user from the bright sunlight. In some examples, the artificial reality device 400 may be in a form of safety glasses which protect the eyes of the user. In some examples, the artificial reality device 400 may be in a form of a night vision device or infrared goggles to enhance vision of a user at night.

For discussion purposes, FIG. 4A shows that the artificial reality device 400 includes a frame 405 configured to mount to a head of a user, and left-eye and right-eye display systems 410L and 410R mounted to the frame 405. FIG. 4B is a cross-sectional view of half of the artificial reality device 400 shown in FIG. 4A according to an example of the present disclosure. For discussion purposes, FIG. 4B shows the cross-sectional view associated with the left-eye display system 410L. The frame 405 is merely an example structure to which various components of the artificial reality device 400 may be mounted. Other suitable type of fixtures may be used in place of or in combination with the frame 405.

In some examples, one or both of the left-eye and right-eye display systems 410L and 410R may include suitable image display components configured to generate an image light representing a virtual image, and guide the image light toward the eye-box region 259. In some examples, one or both of the left-eye and right-eye display systems 410L and 410R may include suitable optical components configured to direct the image light toward the eye-box region 259. For illustrative purposes, FIG. 4B shows that the left-eye display systems 410L may include the light source assembly 205 (e.g., a projector) coupled to the frame 405 and configured to generate the image light representing a virtual image. In some examples, one or both of the left-eye and right-eye display systems 410L and 410R may include a waveguide display system disclosed herein, e.g., the system 200 shown in FIGS. 2A-3E. Thus, the artificial reality device 400 may provide a significantly increased eye-box efficiency through the system 200.

The present disclosure provides a system. The system includes a waveguide configured to guide an in-coupled image light to propagate inside the waveguide via total internal reflection; an in-coupling element configured to couple an input image light into the waveguide as the in-coupled image light; a plurality of partial reflectors at least partially embedded inside the waveguide; and an in-plane relay at least partially embedded inside the waveguide and disposed between the in-coupling element and the partial reflectors. The in-plane relay includes a plurality of cylindrical reflectors. The in-plane relay is configured to convert the in-coupled image light received from the in-coupling element into a relayed image light.

In some examples, the plurality of cylindrical reflectors include at least one cylindrical mirror. In some examples, the in-coupled image light includes a plurality of bundles of first parallel rays, and the in-plane relay is configured to convert the plurality of bundles of first parallel rays into a plurality of bundles of second parallel rays included in the relayed image light. In some examples, the plurality of cylindrical reflectors include a first cylindrical reflector and a second cylindrical reflector arranged opposite to the first cylindrical reflector. The first cylindrical reflector is configured to reflect the plurality of bundles of first parallel rays as a plurality of bundles of non-parallel rays propagating toward the second cylindrical reflector via total internal reflection, and the second cylindrical reflector is configured to reflect the plurality of bundles of non-parallel rays as the plurality of bundles of second parallel rays.

In some examples, the in-plane relay is configured to relay a virtual image represented by the in-coupled image light received from the in-coupling element to an intermediate image plane located at a predetermined portion of the waveguide. The partial reflectors are at least partially embedded at the predetermined portion.

In some examples, the partial reflectors are configured to split the relayed image light into a plurality of redirected image lights propagating inside the waveguide. In some examples, the partial reflectors are first partial reflectors, and the system further includes a plurality of second partial reflectors at least partially embedded inside the waveguide. The first partial reflectors are disposed between the in-plane relay and the second partial reflectors.

In some examples, the relayed image light output from the in-plane relay is incident onto the first partial reflectors as a first convergent image light, and the redirected image lights are incident onto the second partial reflectors as second convergent image lights. In some examples, the second partial reflectors are configured to couple the redirected image lights out of the waveguide as a plurality of output image lights. In some examples, at least one of the output image lights propagates convergently and then divergently toward an eye-box region of the system.

In some examples, the in-plane relay is configured to relay a virtual image represented by the in-coupled image light received from the in-coupling element to an intermediate image plane located at a predetermined portion of the waveguide, and the first partial reflectors are at least partially embedded at the predetermined portion.

In some examples, the in-plane relay is configured to relay a virtual image represented by the in-coupled image light received from the in-coupling element to an intermediate image plane located at a predetermined portion of the waveguide, and the second partial reflectors are at least partially embedded at the predetermined portion.

In some examples, the in-plane relay is configured to relay a virtual image represented by the in-coupled image light received from the in-coupling element to an intermediate image plane located between a first portion of the waveguide and a second portion of the waveguide, the first partial reflectors are at least partially embedded at the first portion, and the second partial reflectors are at least partially embedded at the second portion.

In some examples, the in-plane relay is configured to relay a virtual image represented by the in-coupled image light received from the in-coupling element to an intermediate image plane located within an eye-box region of the system. In some examples, the in-plane relay is configured to form one of a 4-f imaging assembly, a 2-f imaging assembly, a 1-f imaging assembly, or a 0.5-f imaging assembly. In some examples, the in-plane relay is configured to at least partially correct an optical aberration in the in-coupled image light. In some examples, one or more of the plurality of cylindrical reflectors have a non-optical power direction along a thickness direction of the waveguide. In some examples, one or more of the plurality of cylindrical reflectors include at least one of a concave cylindrical mirror, a convex cylindrical mirror, or a freeform cylindrical mirror. In some examples, the partial reflectors include flat partial reflective surfaces arranged in parallel, and one or more of the flat partial reflective surfaces form an acute angle with respect to a surface perpendicular to a thickness direction of the waveguide. In some examples, the relayed image light is incident onto the partial reflectors as a convergent image light. In some examples, the in-coupling element includes at least one of a mirror or a grating. In some examples, the out-coupling element includes at least one of a mirror or a grating.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In some embodiments, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Various aspects of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and features of different embodiments may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a waveguide configured to guide an in-coupled image light to propagate inside the waveguide via total internal reflection;
an in-coupling element configured to couple an input image light into the waveguide as the in-coupled image light;
a plurality of partial reflectors at least partially embedded inside the waveguide; and
an in-plane relay at least partially embedded inside the waveguide and disposed between the in-coupling element and the partial reflectors,
wherein the in-plane relay includes a plurality of cylindrical reflectors, and
wherein the in-plane relay is configured to convert the in-coupled image light received from the in-coupling element into a relayed image light.

2. The system of claim 1, wherein the plurality of cylindrical reflectors include at least one cylindrical mirror.

3. The system of claim 1, wherein
the in-coupled image light includes a plurality of bundles of first parallel rays, and
the in-plane relay is configured to convert the plurality of bundles of first parallel rays into a plurality of bundles of second parallel rays included in the relayed image light.

4. The system of claim 3, wherein
the plurality of cylindrical reflectors include a first cylindrical reflector and a second cylindrical reflector arranged opposite to the first cylindrical reflector,
the first cylindrical reflector is configured to reflect the plurality of bundles of first parallel rays as a plurality of bundles of non-parallel rays propagating toward the second cylindrical reflector via total internal reflection, and
the second cylindrical reflector is configured to reflect the plurality of bundles of non-parallel rays as the plurality of bundles of second parallel rays.

5. The system of claim 1, wherein the in-plane relay is configured to relay a virtual image represented by the in-coupled image light received from the in-coupling element to an intermediate image plane located at a predetermined portion of the waveguide, wherein the partial reflectors are at least partially embedded at the predetermined portion.

6. The system of claim 1, wherein the partial reflectors are configured to split the relayed image light into a plurality of redirected image lights propagating inside the waveguide.

7. The system of claim 6, wherein
the partial reflectors are first partial reflectors, and the system further comprises a plurality of second partial reflectors at least partially embedded inside the waveguide, and
the first partial reflectors are disposed between the in-plane relay and the second partial reflectors.

8. The system of claim 7, wherein the relayed image light output from the in-plane relay is incident onto the first partial reflectors as a first convergent image light, and the redirected image lights are incident onto the second partial reflectors as second convergent image lights.

9. The system of claim 8, wherein the second partial reflectors are configured to couple the redirected image lights out of the waveguide as a plurality of output image lights.

10. The system of claim 9, wherein at least one of the output image lights propagates convergently and then divergently toward an eye-box region of the system.

11. The system of claim 7, wherein
the in-plane relay is configured to relay a virtual image represented by the in-coupled image light received from the in-coupling element to an intermediate image plane located at a predetermined portion of the waveguide, and
the first partial reflectors are at least partially embedded at the predetermined portion.

12. The system of claim 7, wherein
the in-plane relay is configured to relay a virtual image represented by the in-coupled image light received from the in-coupling element to an intermediate image plane located at a predetermined portion of the waveguide, and
the second partial reflectors are at least partially embedded at the predetermined portion.

13. The system of claim 7, wherein
the in-plane relay is configured to relay a virtual image represented by the in-coupled image light received from the in-coupling element to an intermediate image plane located between a first portion of the waveguide and a second portion of the waveguide,
the first partial reflectors are at least partially embedded at the first portion, and
the second partial reflectors are at least partially embedded at the second portion.

14. The system of claim 7, wherein the in-plane relay is configured to relay a virtual image represented by the in-coupled image light received from the in-coupling element to an intermediate image plane located within an eye-box region of the system.

15. The system of claim 1, wherein the in-plane relay is configured to form one of a 4-f imaging assembly, a 2-f imaging assembly, a 1-f imaging assembly, or a 0.5-f imaging assembly.

16. The system of claim 1, wherein the in-plane relay is configured to at least partially correct an optical aberration in the in-coupled image light.

17. The system of claim 1, wherein one or more of the plurality of cylindrical reflectors include at least one of a concave cylindrical mirror, a convex cylindrical mirror, or a freeform cylindrical mirror.

18. The system of claim 1, wherein
the partial reflectors include flat partial reflective surfaces arranged in parallel, and
one or more of the flat partial reflective surfaces form an acute angle with respect to a surface perpendicular to a thickness direction of the waveguide.

19. The system of claim 1, wherein the relayed image light is incident onto the partial reflectors as a convergent image light.

20. The system of claim 1, wherein the in-coupling element includes at least one of a mirror or a grating.
